(19) United States
(12) Patent Application Publication
(10) Pub. No.: US 2026/0059413 A1
(43) Pub. Date: Feb. 26, 2026

(54) COORDINATED HANDOVER FOR A GROUP OF WTRUS USING XR AND MEDIA APPLICATIONS

(71) Applicant: INTERDIGITAL PATENT HOLDINGS, INC., Wilmington, DE (US)

(72) Inventors: Magurawalage Chathura Madhusanka Sarathchandra, London (GB); Michael Starsinic, Newtown, PA (US); Rocco Di Girolamo, Laval (CA); Jaya Rao, Montreal (CA); Achref Methenni, Montreal (CA); Xavier De Foy, Kirkland (CA); Renan Krishna, Brighton (GB); Michelle Perras, Montreal (CA); Saad Ahmad, Montreal (CA)

(73) Assignee: INTERDIGITAL PATENT HOLDINGS, INC., Wilmington, DE (US)

(21) Appl. No.: 19/102,667

(22) PCT Filed: Aug. 11, 2023
(86) PCT No.: PCT/US2023/030089

§ 371 Date: Feb. 10, 2025

Related U.S. Application Data
(60) Provisional application No. 63/397,243, filed on Aug. 11, 2022.

(51) Int. Cl. H04W 36/30; H04W 36/36

(52) U.S. Cl. CPC H04W 36/304; H04W 36/362

(57) ABSTRACT

A system and method allowing a group of WTRUs in a group to be handed over in a coordinated manner are disclosed. The system and method include procedures for handling mobility and handover for a subset of WTRUs or all WTRUs belonging to a group, considering application layer requirements. Included procedures enable a single WTRU within a group of WTRUs to trigger handover for other WTRUs within the group. The system and method include procedures enabling a single WTRU to act as an anchor WTRU for handover control messages, allowing it to override handover messages sent by the network, allowing one WTRU in a group to coordinate handovers for all or a subset of WTRUs.

### CROSS-REFERENCE TO RELATED APPLICATIONS

This application claims the benefit of U.S. Provisional Application No. 63/397,243, filed Aug. 11, 2022, the contents of which are incorporated herein by reference.

### BACKGROUND

A PDU Set includes one or more PDUs carrying the payload of one unit of information generated at the application level (e.g., a frame or video slice for XRM Services), which are of same importance requirement at application layer. All PDUs in a PDU Set may be needed by the application layer to use the corresponding unit of information. In some situations, the application layer may recover parts of the information unit, when some PDUs are missing.

A multi-modal synchronization threshold may be defined as the maximum tolerable temporal separation of the onset of two stimuli, one of which is presented to one sense and the other to another sense, such that the accompanying sensory objects are perceived as being synchronous. A synchronization threshold may be described as the maximum tolerable temporal separation between the transmission or reception of two flows.

In the definition of a PDU Set, the unit of information may be an Application Layer unit of information. The terms “unit of information” and “application layer unit of information” may be used interchangeably. The terms Application Server and Application Function may be used interchangeably.

### SUMMARY

A system and method allowing a group of WTRUs in a group to be handed over in a coordinated manner are disclosed. The system and method include procedures for handling mobility and handover for a subset of WTRUs or all WTRUs belonging to a group, considering application layer requirements. Included procedures enable a single WTRU within a group of WTRUs to trigger handover for other WTRUs within the group. The system and method include procedures enabling a single WTRU to act as an anchor WTRU for handover control messages, allowing it to override handover messages sent by the network, allowing one WTRU in a group to coordinate handovers for all or a subset of WTRUs.

A system and method performed in a wireless transmit receive unit (WTRU) for coordinated handover for a group of WTRUs are disclosed. The system and method include a transceiver and processor for receiving a first coordinated handover configuration, receiving a handover notification, the handover notification alerting to a coordinated handover and including at least one handover condition to trigger the coordinated handover, setting a handover threshold based on the handover condition, determining a measurement value, and performing the coordinated handover when measurement value meets the handover threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A illustrates an example signal diagram for an inter-gNB handover procedure;

FIG. 2B includes a method for an inter-gNB handover procedure;

FIG. 4A illustrates an example signal diagram of a planned group handover;

FIG. 4B illustrates a method for a planned group handover; illustrates a signaling diagram for a legacy handover;

FIG. 4A illustrates an example signal diagram of a planned group handover;

FIG. 4B illustrates a method for a planned group handover;

FIG. 5A illustrates an example signal diagram for a WTRU triggered group handover;

FIG. 5B includes a method performed in a WTRU for coordinated handover for a group of WTRUs;

FIG. 6A illustrates a signal diagram for an anchor-based handover; and

FIG. 6B illustrates a method performed by an anchor WTRU.

### DETAILED DESCRIPTION

Disclosed are systems, methods and devices which allow a group of WTRUs in a group to be handed over in a coordinated manner. The systems, methods and devices may handle mobility and handover for a subset of WTRUs or all WTRUs belonging to a group, considering application layer requirements. The systems, methods and devices enable a single WTRU within a group of WTRUs to trigger handover for other WTRUs within the group. The systems, methods and devices enable a single WTRU to act as an anchor WTRU for handover control messages, allowing the WTRU to override handover messages sent by the network, allowing one WTRU in a group to coordinate handovers for all or a subset of WTRUs.

A system and method performed in a wireless transmit receive unit (WTRU) for coordinated handover for a group of WTRUs are disclosed. The system and method include a transceiver and processor for receiving a first coordinated handover configuration, receiving a handover notification, the handover notification alerting to a coordinated handover and including at least one handover condition to trigger the coordinated handover, setting a handover threshold based on the handover condition, determining a measurement value, and performing the coordinated handover when measurement value meets the handover threshold.

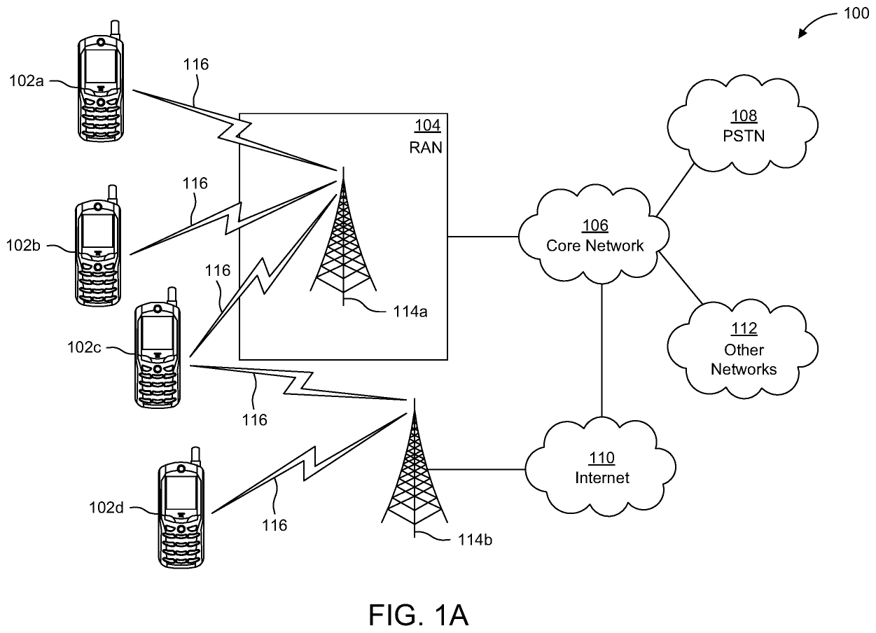

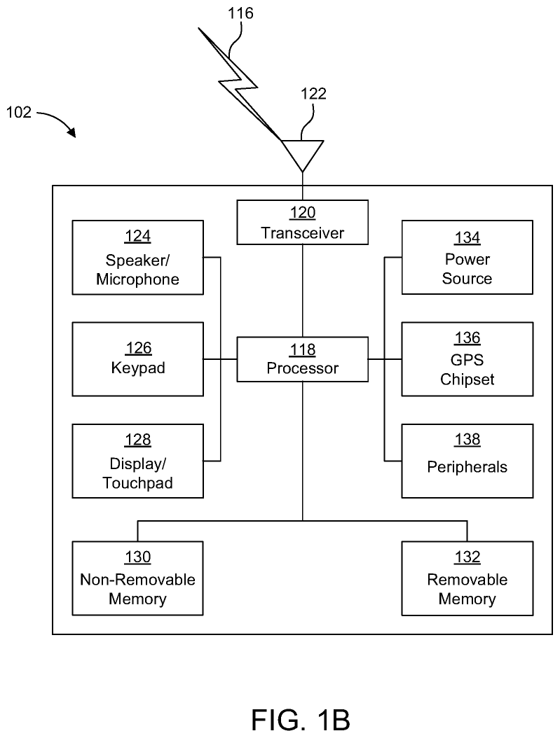

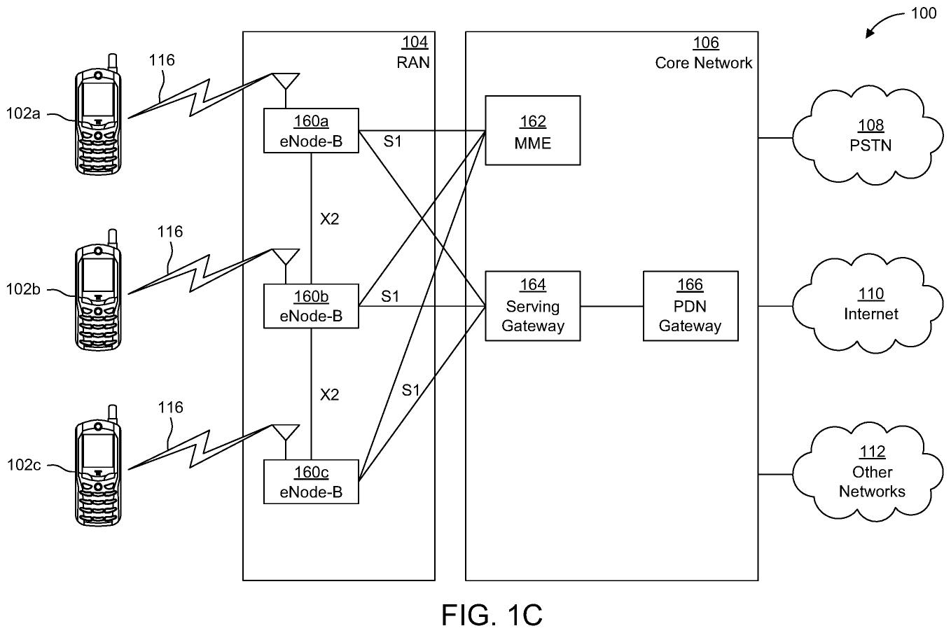

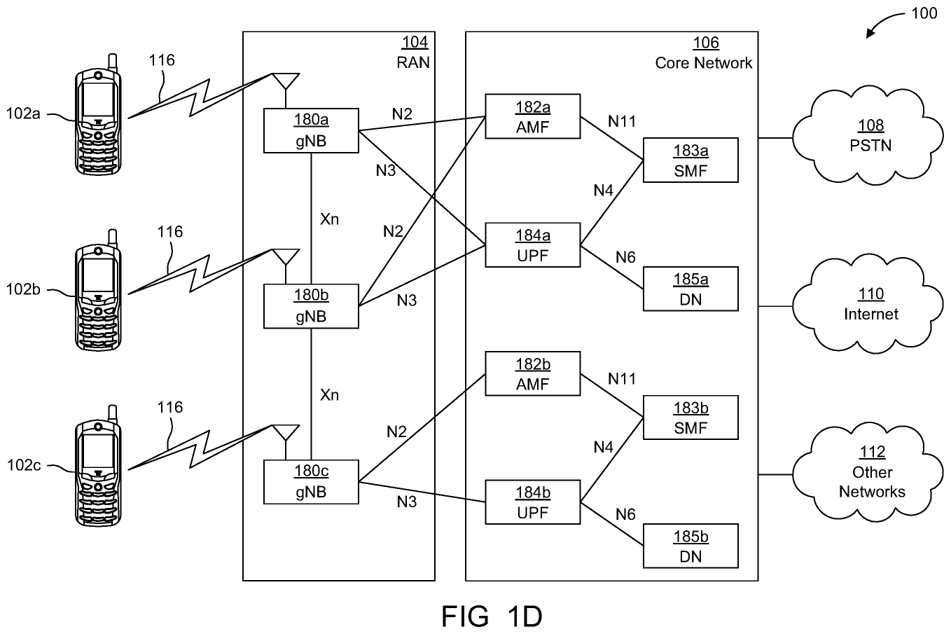

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Multi-modal data is input data from different kinds of devices/sensors or the output data to different kinds of destinations (e.g., one or more WTRUs) required for the same task or application. Multi-modal data may include more than one single-modal data and may include a strong dependency among each single-modal data. Single-modal data may be one type of data. A device or sensor that generates (i.e., sends) single-modal data may be a WTRU or may use a WTRU to send single-modal data to a network. Single-modal data may be sent to applications that are hosted on other WTRUs or applications that are hosted on network servers. A device or sensor that receives single-modal data may be a WTRU or may use a WTRU to receive single-modal data from a network. Single-modal data may be received from applications that are hosted on other WTRUs or applications that are hosted on network servers.

Synchronization thresholds define the maximum tolerable temporal separation of the onset of two stimuli. In most scenarios, one stimuli may be transferred over one flow, while the second may be transferred over another. One stimuli may be presented to one human sense (sight) and the other to another sense (touch), such that the corresponding sensory objects are perceived as being synchronous.

Traffic characteristics or patterns of multimodal flows may differ depending on the application. For example, a well-known category of multimodal use cases is virtual reality (VR) applications. In such applications, user pose change information may be captured by a VR headset and sent over the network to an application server in the network. Received pose information is processed and new VR information is generated by the application server, including new multimodal data (e.g., audio, video and haptic) corresponding to the changes in the VR environment. Multimodal data are then sent to the VR headset over the downlink, allowing the multimodal data to be processed and presented to the user. Therefore, the typical characteristics of the application include, periodic and small amounts of data being sent over the uplink to the application server, followed up by, often relatively larger amounts of, multimodal data sent over the downlink to the VR headset.

Latency may be specified and may need to meet certain minimum requirements between the user's head movement (referred to as ‘motion’) and presenting or displaying updated (information on the VR environment) multimodal information received on the downlink (referred to as ‘photon’ for video and ‘sound’ for audio) to the user using WTRU(s), based on the resulted change in the pose information that is received over the uplink. This may include motion-to-photon latency in the range of 7 ms to 15 ms while maintaining the required resolution of up to 8k giving user data rate of up to 1 Gbit/s and motion-to-sound delay of <20 ms.

Single-modal data is described as being a data flow to and/or from a WTRU and multi-modal data is described as including multiple data flows to and/or from multiple WTRUs.

A multi-modal data set is the set of single-modal data flows that are used for the same task or application. For example, a multi-modal data set may be a set of IP flows and/or QoS flows (identified by QoS Flow Identifiers [QFI]) between multiple WTRUs and a single Application Server. For example, the IP Flows may carry sensor data, video information, haptic data, audio data, etc.

Handover procedures, such as in 5G systems, may be network controlled and categorized into two types of mobility, such as cell level mobility and beam level mobility. Cell level mobility requires explicit RRC signaling to be triggered.

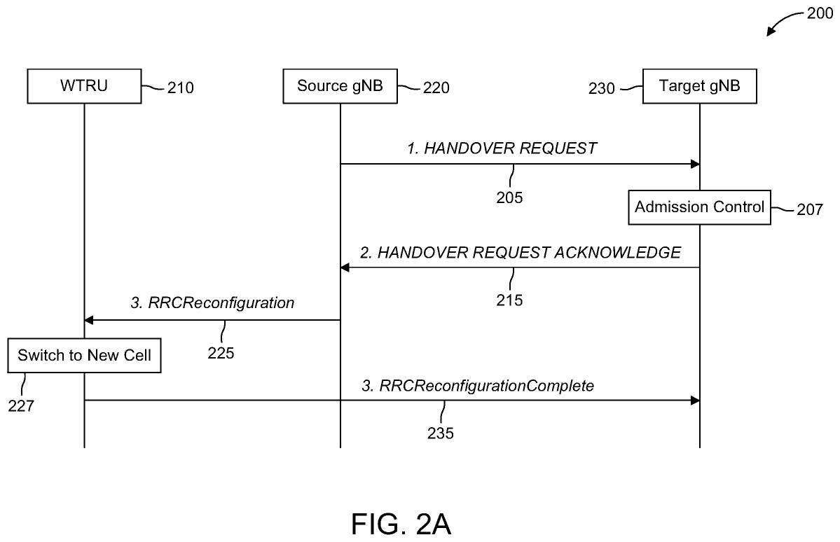

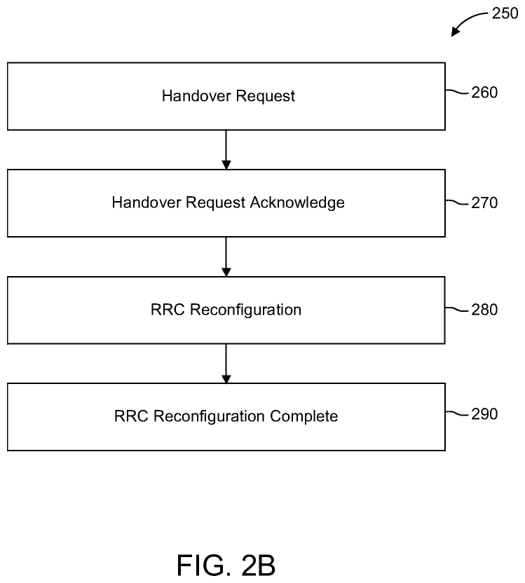

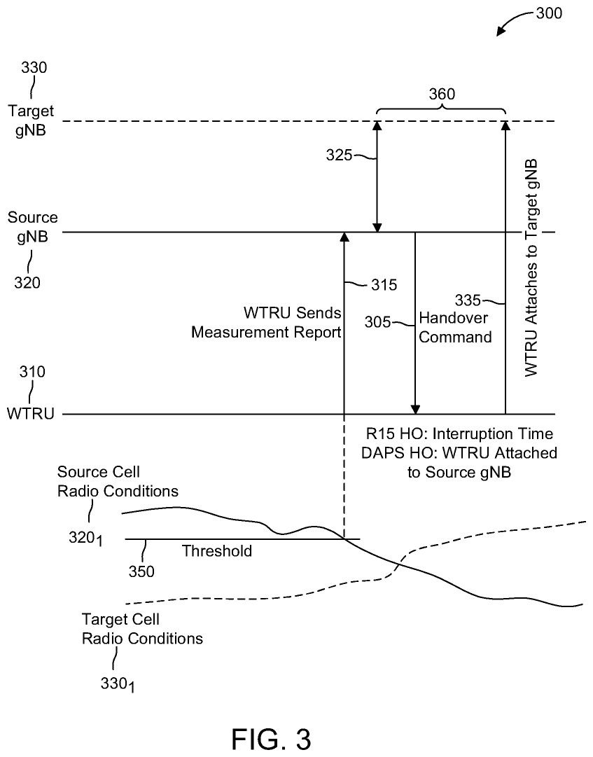

FIG. 2A illustrates an example signal diagram 200 for an inter-gNB handover procedure. Example signal diagram 200 includes a WTRU 210, a source gNB 220 and a target gNB 230. While singular version of WTRU 210, source gNB 220 and target gNB 230, it is understood that multiple ones may be used in each case, and that the singular depiction is to provide a clearer understanding of the signaling in the present procedure.

As can be seen in FIG. 2A illustrates an example signal diagram for an inter-gNB handover procedure;

A, cell level mobility includes inter-gNB handover. The signal diagram 200 commences with the source gNB 220 sending a handover request 205 to the target gNB 230. For example, in inter-gNB handover, the source gNB 220 initiates handover, and issues a handover request over the Xn Interface to target gNB 230. Target gNB 230 performs 207 admission control procedures and sends a handover request acknowledgement 215 to source gNB 220. For example, once admission control procedures are performed by target gNB 230, target gNB 230 provides the new RRC configuration in its response to source gNB 220. Source gNB 220 sends an RRC Reconfiguration message 225 to WTRU 210. For example, RRC Reconfiguration message 225 may include at least a cell ID and all information required to access the target cell (e.g., beam specific information). WTRU 210 upon receipt of the RRC Reconfiguration message 225, switches 227 to a new cell. For example, WTRU 210 performs the handover. WTRU 210 sends an RRC Reconfiguration complete message 235 to target gNB 230 to complete the handover.

FIG. 2B includes a method 250 for an inter-gNB handover procedure. Method 250 includes providing a handover request at 260 from on old gNB (currently used gNB) to a new gNB (potential gNB for handover). At 270, method 250 includes a handover request acknowledgement from the new gNB to the old gNB. At 280, method 250 includes an RRC Reconfiguration message being sent from the original gNB to the WTRU. At 290, method 250 includes sending an RRC reconfiguration complete message to the new gNB.

When supporting intra-NR RAN handover procedures, messages may be directly exchanged between the gNBs via the Xn interface, e.g., for transferring WTRU 210 context from source gNB 220 to target gNB 230. Resources at the source gNB 220 are released once the handover completion phase is triggered by the target gNB 230.

In conventional HO procedures, WTRU 210 releases the connection to the source cell before establishing connectivity to the target cell, terminating uplink and downlink transmissions. This causes an interruption to the services in the range of few tens of milliseconds (typically around 30-60 milliseconds). To address this issue Dual Active Protocol Stack (DAPS) has been introduced. During handover, DAPS allows WTRU 210 to establish connectivity to both source and target cells (in some examples only Primary Cells (PCells) are used) simultaneously for a short period of time, allowing the connectivity to the source cell to remain active for the reception and transmission of user data, until data can be sent and received in the target cell. Once the handover is complete, the uplink transmission of user data is switched to the target cell at the completion of random-access procedure. For the source and target cells, a common PDCP entity is configured, and the PDCP sequence number continuation is maintained throughout enabling in-sequence delivery of user data. Downlink user data are forwarded from the source cell (for transmitting to the WTRU until the handover is complete) to the target cell (buffered for transmitting to the WTRU once the handover is complete) in a parallel configuration. Once the handover is complete, uplink user data is switched from the source cell to the target cell. The source cell stops transmitting data in downlink once the target cell informs the source cell of the successful handover. If the handover fails, the WTRU falls back to the source cell.

The Conditional Handover (CHO) may be a handover procedure that is executed by WTRU 210 based on the CHO configuration received from network, aimed at reducing the failures when the user is on the move. The WTRU may perform the handover when one or more conditions defined for handover are met. Once the CHO configuration is received by WTRU 210, WTRU 210 may start evaluating the execution conditions, and may stop once a handover is executed. Instead of preparing one target cell, CHO may prepare multiple candidate target cells, allowing the handover command to be sent to WTRU 210 when the radio configurations are still good. This reduces any potential Handover failures which may occur due to bad radio conditions, as in the legacy handover procedures. The CHO configuration contains the candidate cells and the execution conditions generated by source gNB 220. Execution conditions consists of one or two trigger conditions (e.g., SSB and/or CSI-RS measurements).

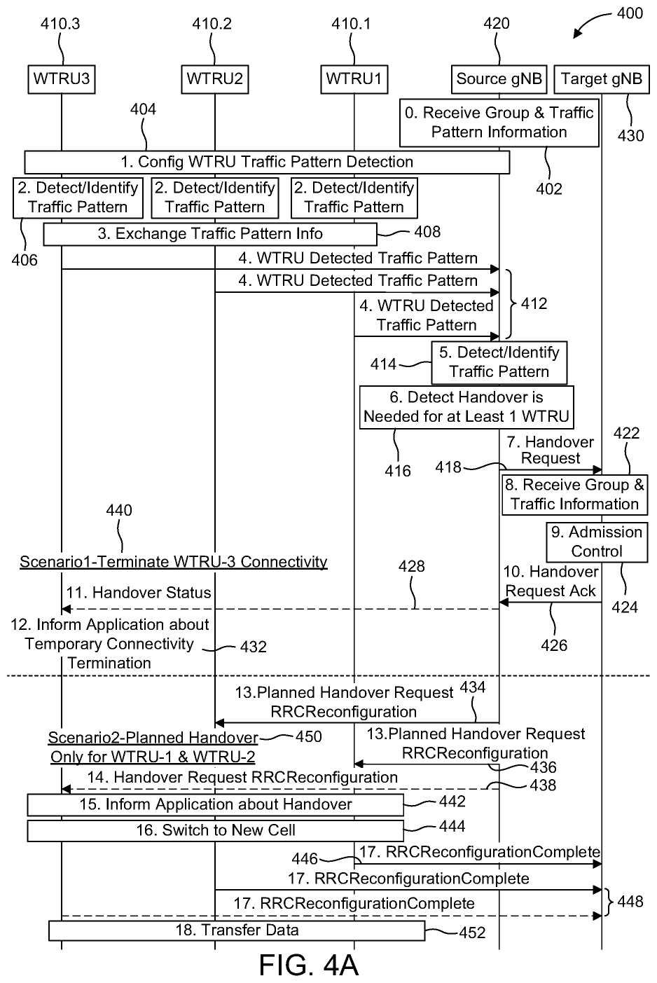

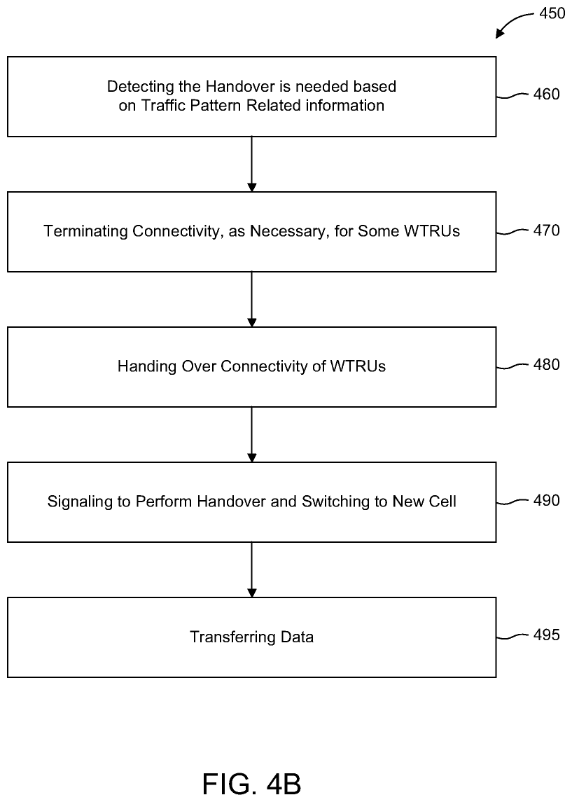

FIG. 4A illustrates an example signal diagram of a planned group handover;

FIG. 4B illustrates a method for a planned group handover; illustrates a signaling diagram 300 for a legacy HO. Diagram 300 may depict a DAPS HO also. Diagram 300 depicts a single WTRU 310 interacting with a source gNB 320 and a target gNB 330. At a first time, WTRU 310 sends a measurement report 315 to the source gNB 320. The measurements performed by WTRU 310 on various physical layer parameters (e.g., SSB and/or CSI-RS) to calculate the cell quality may be used by WTRU 310 and/or network when determining whether to perform a handover.

At 325, source gNB 320 and target gNB 330 exchange messages to prepare a handover procedure. Messages 325 may be used to exchange status information. The status information may be used in preparation for the handover to target gNB 330. In 325, target gNB 330 may indicate if the handover is accepted in a message to source gNB 320.

Source gNB 320 issues a handover command 305 to WTRU 310. The handover is triggered by source-gNB 320 by sending a RRCReConfiguration message to WTRU 310.

WTRU 310 subsequently attaches to target gNB 330 by signaling 335. Once the triggering conditions for performing handover are met (e.g., measurement of CSI-RS from source cell is below a threshold and/or measurement of CSI-RS from target cell is above a threshold), WTRU 310 may synchronize to the target cell and may complete the RRC handover procedure by sending RRCReconfigurationComplete message 335 to target gNB 330. The system may not consider what uplink and downlink user plane procedures are taking place, or those that may soon need to take place, when determining when to initiate the handover procedure, leading to various issues such as, delayed transmission of important data, retransmission of data causing further delay and resource waste due to the disruption to the connectivity caused by handover.

A plot of the respective radio conditions is provided on the bottom of the diagram 300. The plot illustrates a threshold 350 and the source cell radio conditions 3201 and the target cell radio conditions 3301. As illustrated, the measurement report signal 315 is sent when the source cell radio conditions 3201 fall below threshold 350 For a legacy HO, grey area 360 illustrates the interruption time. Generally, no uplink or downlink traffic can be transmitted over this time.

For a DAPS HO, grey area 360 illustrates the time during which WTRU 310 attempts to attach to target gNB 330 but remains attached to source gNB 320. During this time represented by grey area 360, source gNB 320 forwards packets to target gNB 330, where the packets are buffered waiting for WTRU 310 to attach to the target gNB 330. During this time represented by grey area 360, the radio quality over source gNB 320 may be poor.

Although not shown, the conditional HO also suffers from interruption time.

Users may consume a multi-modal application data in varying scenarios while the users are mobile. The user may own multiple devices with varying capabilities and form factors (e.g., headphones for audio, haptic suit for haptic, VR glasses for video). In such scenarios, the user may use those WTRUs simultaneously to consume data from the same application server. However, as the user moves (e.g., in a vehicle or walking), from one location to another, the user's connection may be handed over from a first cell to a second cell, due to degraded connectivity associated with the first cell, for example. Downlink and Uplink data may be delayed during the handover as outlined in FIG. 3 above. Delaying XRM data that has relatively strict delay, jitter, and synchronization requirements may result in the user perceiving a data interruption or relatively lower quality of experience. Furthermore, when a group of devices moves together (e.g., when in the same vehicle or attached to the same person) it is important to minimize differences in the overall delay that is associated with the flows of the devices. For example, if one device performs a handover operation before a second device, then the delay that is observed at each device may temporarily increase. In multi-modal applications, this increase in delay that is experienced at one device and not experienced at a second device may cause a negative user experience due to flows becoming unsynchronized.

When handover procedures are performed there is a period time when uplink and downlink data may be delayed as illustrated in FIG. 3. As a result, the XRM services that are being provided to the user may be disrupted until the handover procedure is completed. However, multi-modal communication involves the transmission of modes of data with varying requirements-some are more stringent than others (e.g., latency requirements of haptic data is more stringent than video and audio data). Violating the requirements of one mode of data may affect the whole application experience (i.e., reduction in QoS and QoE). Therefore, when performing handover for WTRUs that are associated with multi-modal sessions, the disruption to these services can be minimized.

The state of other WTRUs that are part of the same application experience may not be considered when determining when to initiate and then perform the handover. Performing handover without considering the application layer activity is not optimal because data may be delayed during the handover process. This may be even more crucial in scenarios where multiple WTRUs are used. When there is a lack of coordination when performing handover on multiple WTRUs that are used by the user for the same application, handover procedures may be triggered and consequently completed at different times or handover may be optimized by for example, accounting for user plane procedures for individual WTRUs separately, cell quality perceived per each WTRU by the network/WTRU. When handover optimization is carried out for separate WTRUs in isolation, and disruptions and/or changes (application layer changes, e.g., change of codec) to the service of each individual WTRU may occur at different times, it may lead to handover being performed for WTRUs at different times. This may cause the relative delays between interrelated multimodal flows to exceed the maximum synchronization thresholds, affecting the overall QoE, and may also result in an increased total disruption to the whole application experience.

In order to avoid impacts to the overall quality of experience, a benefit may be gained by ensuring that the handover procedure takes place in a coordinated manner between a group of associated WTRUs, between data bursts or during data bursts that are less important. Currently, systems generally do not provide a way to configure a group of WTRUs to initiate the handover at the same time or close to the same time. Such an approach may consider the traffic characteristics (e.g., the periodic nature of some uplink and downlink traffic), the level of importance of a specific set of data (e.g., some video frames are more important than others) within a single-modal flow, and the level of importance of the single-modal flows of a multi-modal session (e.g., audio flows are more important than haptic flows) when determining when to start the handover process. Therefore, taking more than just the cell quality into consideration may minimize disruptions to the overall application experience. In other words, more careful planning of when to initiate the handover may result in less data being delayed and subsequently dropped at the application layer. For example, handover planning may consider the state of other WTRUs that are part of the same application experience.

Group Handover Parameters are presented below for group handover and how the parameters are provisioned. Group WTRU Planned Handover are presented below including procedures for handling mobility and handover for a subset of WTRUs or all WTRUs belonging to a group, considering application layer requirements. WTRU triggered group handover is described below presenting procedures which enable a single WTRU within a group of WTRUs to trigger handover for other WTRUs within the group. These procedures are required in scenarios where a WTRU within a group is ready or required to perform handover before other WTRUs, and in doing so may potentially degrade QoE. Anchoring based group handover is described and presents procedures which enable a single WTRU to act as an anchor WTRU for handover control messages, allowing the single WTRU to override handover messages sent by the network, allowing one WTRU in a group to coordinate handovers for all or a subset of WTRUs. Group Handover Parameters include parameters for group handover procedures, and how the parameters are provisioned within the network. The following parameters may be provisioned to the network by an Application Function or an Application Server in the network (e.g., via the NEF), or by a WTRU. These parameters may be provisioned at the start of an application, and/or may be provisioned/updated multiple times during the lifetime of the application (e.g., triggered by modality or priority change of WTRUs).

A group of WTRUs may be identified by a multimodal session ID, which may be specified by an IP 4-tuple, SUPI, GPSI, or DNN/S-NSSAI combination. This may be shared among a group of WTRUs, and the multimodal session ID may be linked or mapped to the set of WTRUs that the multimodal session has been used or authorized for. Alternatively, the group can be identified with an External Group Identifier.

A second parameter, identifying a specific WTRU (within the group of WTRUs or a WTRU outside the group of WTRUs of interest) for coordinating the group handover process, referred to as an Anchor WTRU, may also be provisioned to the network as well as to the participating WTRUs. Anchor WTRU is used herein to describe a single WTRU that acts as a master or coordinator WTRU who handles handover control signaling for a group of WTRUs. This parameter may be specified as a SUPI, GPSI, IP Address, or a 5G-S-TMSI.

A group of WTRUs, associated with any of a common application, common experience or a common session, may be assigned by the base station with one or more RAN specific group IDs, such as a group-RNTI (G-RNTI), sub-group RNTI or multimodal-RNTI. Such RAN specific group IDs may be assigned in addition to per-WTRU IDs (e.g., C-RNTI), and may be common or shared by the WTRUs in the group when transmitting and/or receiving any RAN signaling (e.g., RRC messages) during handling of connectivity, handover and scheduling related procedures, for example.

The network may maintain the list of WTRU identifiers for the group of WTRUs that may require the group handover. This list may include the WTRUs that have the same multimodal session ID or External Group Identifier, or that are associated with the same common application, common experience or a common session. The WTRUs may provide this information to the RAN nodes through RRC signaling. For example, the WTRU may provide the multimodal session ID in a WTRUAssistanceInformation message. The gNB may maintain a list of WTRU identifiers that share the same multimodal session ID. The network may provide the list of WTRU identifiers to one or more of the WTRUs in the group. A WTRU may use the list of WTRU identifiers for any D2D/SL communication. The WTRU identifier may be a C-RNTI or a L2 Identifier. A ‘handling together’ indication may be provided by the AF/AS to the RAN, and the RAN may be used to determine which WTRUs are highly inter-related and, for example, whether to perform handover for sub-group of WTRUs that are ‘handled together’.

Group WTRU Planned Handover includes procedures which allow coordination of the handover among a group of WTRUs (as described above), such that the handover is triggered and/or completed for all or a subset of WTRUs at a similar time. A priority among the WTRUs (e.g., some WTRUs may have higher affinity/inter-relations (e.g., based on multimodal synchronization thresholds described above)—making the WTRUs more prone to effects resulting in handover, or may be priority assigned based on the modality supported by each WTRU [assigning video modality a higher priority than the haptic modality], or whether the WTRU is an anchor WTRU may dictate which subset of WTRUs get handed over first. The priority assigned to WTRUs may change over time (e.g., prioritize haptic traffic when there is movement expected in the session, or a regular WTRU becomes an Anchor WTRU). In another scenario, only a subset of WTRUs in a group may be handed over to the new cell/gNB (in cases where resources are limited, radio link conditions are not favorable or certain features are not supported by the target cell). Therefore, services to a subset of WTRUs may be terminated temporarily (e.g., until resources become available or can be handed over to a cell that can provide the resources, as the source cell can no longer support the WTRUs and the target cell has limited capacity at the time the handover is approaching).

The following description in conjunction with the description above, provides methods that may be used for performing handover for a group of WTRUs which uses the same multimodal application, while minimizing relative delay between multimodal flows (adhering to synchronization thresholds). In the examples presented below, WTRU-1, WTRU-2 and WTRU-3 are used for the same application, and the network (or the anchor WTRU described below) may perform the handover at the same time for WTRU-1 and WTRU-2.

In a first example group handover represented in FIG. 4A, only a subset of WTRUs is handed over to the target cell/gNB, while the connectivity to other WTRUs in the group are terminated, i.e., WTRU-3 receives a connectivity termination notification, allowing only WTRU-1 and WTRU-2 to communicate. In a second example group handover represented in FIG. 4A, WTRUs that are chosen not to be handed over together in a coordinate manner, receive handover configuration from the network for performing handover in the conventional manner, i.e., WTRU-3 may not be handed over together to the target cell, while WTRU-1 and WTRU-2 are handed over together. The system may be configured to use one of the two aforementioned procedures.

FIG. 4A illustrates an example signal diagram 400 of a planned group handover. Signal diagram 400 depicts a plurality of WTRUs 410 involved in the group handover. Specifically, three WTRUs are shown, although any number of WTRUs may be included in the plurality of WTRUs 410. The three WTRUs depicted include WTRU1 410.1, WTRU2 410.2, and WTRU3 410.3. Signal diagram 400 includes a source gNB 420 and target gNB 430.

At 402, signaling diagram 400 includes the RAN (e.g., source gNB 420) receiving traffic characteristic/pattern information using the procedures defined herein. At 404, signaling diagram 400 includes source gNB 420 configuring WTRU 410 measurement procedures and WTRU 410 reports the characteristic/patterns that are in use according to the configurations. RAN (e.g., source gNB 420) may configure WTRU 410 to detect/identify traffic characteristics/patterns for a specific session. This request includes information received at 402 by the RAN (also defined herein). The request may include an ID uniquely identifying a multimodal session. Preexisting information of traffic characteristic/pattern (e.g., gathered through learning) may be provided to the RAN and WTRU 410. Alternatively, WTRU 410 may receive the information defined herein directly from the corresponding AF/AS(s). This may include configuration and reports defined at 402, 404 in NR standards.

WTRU 410 may be configured by source gNB 420 with one or more handover (HO) modes and/or the parameters associated with the HO modes supported/allowed by RAN. Such handover modes may include normal HO, CHO, DAPS or any other HO procedure that may support HO of multi-modal traffic, for example. Optionally, WTRU 410 analyzes the application traffic to identify the traffic characteristic/patterns (e.g., in UL) at 406. Element 406 may be triggered by messaging sent with respect to element 404. Alternatively, WTRU 410 may initiate element 406 based on pre-configured configurations on the WTRU automatically, without having to receive the messaging sent with respect to element 404. For example, the WTRU starts to monitor and analyze traffic at 406 when a multimodal/XR session has been established.

WTRUs 410 may exchange individually identified or retained traffic characteristic/patterns at 408, such as between other WTRUs within the group using D2D or sidelink communication links for; improving traffic characteristic or pattern related data collaboratively among the group of WTRUs, through learning techniques such as federated learning and distributed learning and enabling all WTRUs to have traffic characteristic/patterns of other WTRUs. This exchanging enables a single WTRU 410 to send traffic characteristic/pattern information of all WTRUs in the group to the RAN at 412.

Optionally, WTRU 410 informs RAN about the identified traffic characteristic/patterns to RAN at 412. Element 412 may be performed by all WTRUs of the group or only by a subset of WTRUs, or a single WTRU. Message 412 may include information about specific traffic characteristic/pattern detected/identified. In certain configurations, message 412 may also inform the RAN of its preferred method of performing the handover (e.g., normal handover, CHO, DAPS).

Optionally, the RAN (e.g., source gNB 420) analyzes the application traffic to identify the traffic characteristics/patterns (e.g., in DL) at 414. Element 414 may be performed in sequence described herein or may be performed in parallel to elements 406-412. Alternatively, in some configurations, traffic analysis for characteristics/pattern recognition may be performed solely by the RAN, and therefore, element 414 may be initiated at the time a multimodal/XR session is established. In some configurations, traffic characteristic/pattern detection/identification may be done in UPF. The UPF may then communicate the result to the RAN.

The RAN (e.g., source gNB 420) detects that handover may be needed at 416 for at least one WTRU in the group, based on measurement information related to the wireless connectivity. Source gNB 420 may analyze received information gathered of the traffic characteristics/patterns from WTRUs in the group, RAN, or UPF. Source gNB 420 may detect if there are opportunities for performing the handover in advance. Single-modal flows may be distributed among the group of WTRUs, and in some scenarios, traffic characteristics/patterns between single-modal flows may vary (e.g., when video traffic may be idle, haptic traffic may not be). Therefore, when deciding the most suitable time for handover, all different characteristics/patterns of the same application received from multiple WTRUs may be taken into consideration (e.g., the idle traffic window of two WTRUs align at a similar time). The RAN may identify whether a subsets of WTRUs within the group may be handed over together, and whether to terminate the connectivity to other WTRUs that are not handed over together.

In some scenarios the application may require multimodal flows, and therefore, the WTRUs associated with those flows to be handled together. A handling together indication, can be provided by the AF/AS to the RAN, and RAN can use it, to determine for example, whether to terminate other WTRUs or reject all WTRUs. This may trigger the application AF/AS to perform changes, if not all WTRUs can be handled together.

Diagram 400 illustrates source gNB sending handover request at 418 to target gNB 430, such as by sending a HANDOVER REQWTRUST over the Xn interface, for example. Request 418 may include WTRU group related information (as described herein) and multimodal application requirements (e.g., synchronization thresholds). Request 418 may include a list of WTRUs to be handed over. Each WTRU in the list may have a priority indication. This priority indication is used in cases target gNB 430 cannot accept all WTRUs in the group. Target gNB 430 may use the priority to decide which of the set of WTRUs to allow for handover. This may include procedures in the standards.

Target gNB 430 may receive WTRU group and Traffic related information at 422 as described herein. Traffic related information may also include requirements of multimodal flows (e.g., synchronization thresholds). Based on information received, target gNB 430 decides whether all WTRUs can be handed over, or which subset of WTRUs can be handed over. Target gNB 430 may perform admission control at 424 for all chosen WTRUs in the group.

In scenarios where not all WTRUs in the group have been handed over to the target cell, if a Handling Together Indication is provided (described herein), RAN/Target cell can inform the application (WTRU or AF/AS) that not all WTRUs have been handed over, and which WTRUs have and haven't been handed over. In this case, the application (e.g., WTRU or AF/AS) may perform corresponding application layer tasks. For example, the AF/AS may change the configuration of modalities (e.g., by reducing the frame rate which may also reduce radio resource utilization for this modality, and hence, freeing up resources in the target cell) while preserving service requirement such as synchronization thresholds, which can allow for the remaining WTRUs to be admitted to the new target cell.

Target gNB 430 may acknowledge handover request by responding with RRC configuration message 426 to source gNB 420 with HANDOVER REQWTRUST ACKNOWLEDGE. Message 426 may include the list of WTRUs that are accepted by target gNB 430 for handover.

In scenarios where only a subset of WTRUs are identified to be handed over to the target cell/gNB and the connectivity to other WTRUs are temporarily terminated at 432 (scenario 1 440), an optional handover status notification 428 is sent to the WTRUs that are chosen not to be handed over, indicating that only some of the WTRUs will be handed over to target gNB 430. The message for connectivity termination 432 may specify when the WTRU can re-attempt to re-establish connectivity or perform handover. This may include a timer, a duration for the termination, a geographical location or other cells/gNB that WTRU may connect to when in coverage. The WTRU may inform the application(s) that the connectivity will be terminated due to handover, in case of scenario 1 440, where a handover notification message indicating that the connectivity to the WTRU will be temporality terminated.

WTRUs 410 that are chosen to be handed over together receive RRCReconfiguration message 434 from the RAN (e.g., source gNB 420), indicating the possibility for performing the handover. This may specify information on when the handover may be performed. A separate RRCReconfiguration message 436 may be sent to each WTRU in the group (e.g., if the configurations are different between WTRUs of the group). Alternately, a single RRCReconfiguration message 434,436 may be sent to the group-RNTI (G-RNTI), sub-group RNTI or multimodal-RNTI, that is configured for the group of WTRUs. In a first type of information, this may refer to traffic characteristics. This may be based on priority of the traffic. For example, handover may be advanced to occur before receiving traffic of a certain priority, or before transmitting traffic of a certain priority. This may be based on a marker in a PDU header. For example, handover may be advanced to occur before receiving traffic that has this marker or transmitting traffic that has this marker. In a second type of information this may refer to specific temporal information (e.g., specific time intervals). In a third type of information, this may refer to traffic quantity. For example, handover may be advanced to occur after the WTRU has received K DL PDUs, or after the WTRU has transmitted K UL PDUs. Moreover, the message may include more than one set of threshold values for triggering the handover. The threshold values may be chosen based on the type of traffic. This message may indicate whether the WTRUs can synchronize a handover time directly between the WTRUs (which may be used when a specific handover time is not specified by the RAN) over D2D communication links. The message 434,436 may include the information of the cell that they are handing over to (e.g., Cell ID).

In some scenarios, a message indicating the possibility of a handover is sent to the relevant AF/AS(s), so that AF/AS(s) can decide whether to perform any relevant application layer operations.

In the second scenario, the chosen not to be handed over together WTRUs receive the RRCReconfiguration message 438 from the RAN (e.g., source gNB 420), triggering the normal handover procedures. Message 438 may also include the information of the cell that they are handing over to (e.g., Cell ID).

WTRU 410 may inform at 442 the application about the imminent handover, so that decisions on relevant application layer adjustments can be made (e.g., decide whether to change video codec or not, due to disruption caused to the connectivity when performing handover). In other words, the WTRU application is informed that a handover event has occurred or is imminent. The WTRU Application may use this information when considering how to, and whether to adjust codec settings. For example, the WTRU application may normally determine to adjust a codec setting, such as frame rate, when a number of packets are dropped or received in error but may choose to forgo such a setting change if a handover occurred. This may be because the WTRU Application may assume that the dropped packets were due to transient event (i.e., the handover). The application (e.g., at the WTRU and/or AF/AS) may be informed of the subset of WTRU that are, disconnecting temporarily, or configured to fall back to normal HO, and the WTRU/Application may make a decision to change parameters for the traffic, to help fit WTRUs for handover, for example by changing the index of the QoS rules (if each modality has been configured with multiple PCC rules indexed depending on the codec setting, or frames per second (fps) used for each modality to make sure WTRUs can be all eligible).

WTRUs may perform the handover at 444 when the chosen conditions are met, e.g., the WTRU is not receiving or sending critical data. The handover may be performed during a time identified (e.g., specific time window, start and end of burst of data may be identified, and the handover is performed at the end of a burst). The WTRUs may send RRCReconfigurationComplete message 446, 448 to target gNB 430 once they move the RRC connection to target gNB 430. Furthermore, on some configurations of this procedure, WTRU 410 may include the reason/condition of handover in the message, e.g., handover performed because of choosing the threshold value set 1.

There may be a transfer and receipt of data at 452. This may include any data that were held/buffered at either WTRU or RAN, or both, before performing the handover, e.g., high priority data.

As presented, the procedures may allow handover for a group or a subset of WTRUs (e.g., ones with more stringent synchronization thresholds) within a group to be planned, such that the handover is performed in a coordinated manner. They also allow the connectivity to some WTRUs to be terminated temporarily, or their handover to be performed using the normal handover procedures, allowing to prioritize a subset of WTRUs. This enables the system to ensure that delay requirements (e.g., synchronization threshold) of applications are met.

FIG. 4B illustrates a method 450 for a planned group handover. Method 450 includes detecting the handover is needed based on traffic pattern related information at 460. At 470, method 450 includes terminating connectivity, as necessary, for some WTRUs. This termination may be determined by the target gNB, for example. At 480, method 450 includes handing over connectivity of WTRUs. At 490, method 450 includes signaling to perform handover and switching to new cell. At 495, method 450 includes transferring data.

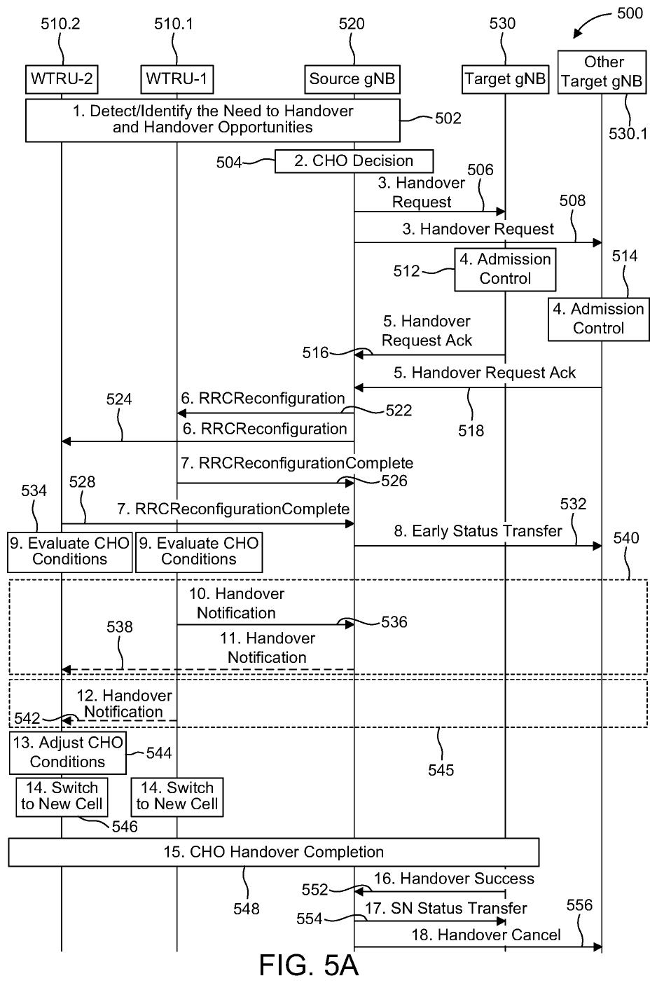

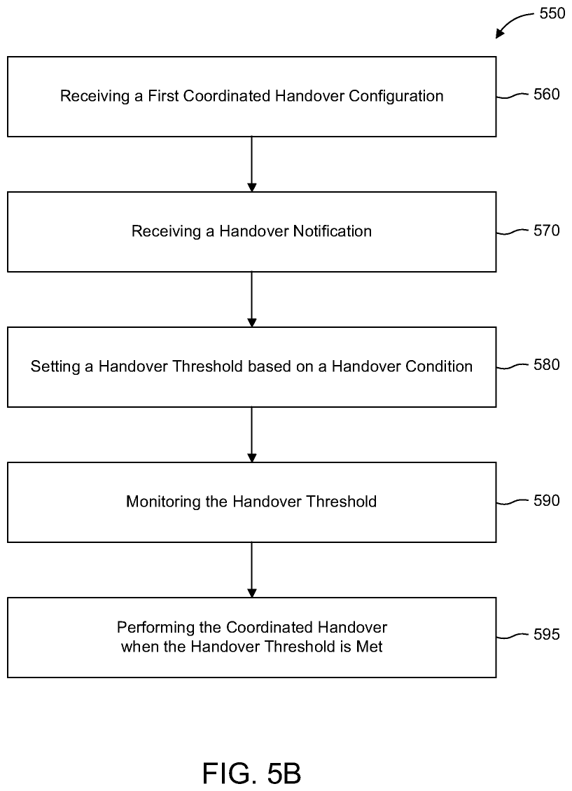

FIG. 5A illustrates an example signal diagram 500 for a WTRU triggered group handover, such as by using CHO. Signal diagram 500 depicts a plurality of WTRUs 510 involved in the group handover. Specifically, two WTRUs are shown, although any number of WTRUs may be included in the plurality of WTRUs 510. The two WTRUs depicted include WTRU1 510.1, and WTRU2 510.2. Signal diagram 500 includes a source gNB 520 and target gNB 530, as well as other target gNBs 530.1. The initial elements described above with respect to FIG. 4A are included. These initial elements include element 502, for example.

In some configurations, the WTRU may inform the RAN that its preference to use CHO, along with its reason (e.g., CHO preferred/required due to latency requirements of the haptic flow in UL). Then, this information may be used when deciding whether to use CHO.

WTRU triggered group handover enables a WTRU to notify some or all WTRUs in a group about when it plans on handing over to another cell/gNB. Although, the procedures utilize CHO procedures, normal HO procedures may also be amended, allowing a WTRU to trigger the group handover. This WTRU notification informs the WTRUs that a second WTRU is handing over to target cell-X. This WTRU notification may causes the WTRU to determine to handover more easily to cell-X (e.g., thresholds are lowered aiming to coordinate the handover between the WTRUs of the group, in order to minimize their interruption time and preserve synchronization between multimodal flows).

FIG. 5A illustrates two examples for sending handover notifications. In the first example of FIG. 5A, a WTRU that is ready to handover (WTRU-1) notifies other WTRUs that are chosen (by the RAN in the exemplary procedures below) to be handed over together via the network. In the second example of FIG. 5A, WTRU-1 sends the handover notification to other WTRUs that are chosen to be handed over together directly using D2D/SL communication.

Source gNB 520 may use CHO at 504, for all or a sub-set of the WTRUs in the group based on the information of the traffic characteristic/pattern. For example, due to strict latency requirements of some flows of the multimodal session, the RAN may perform CHO only on corresponding WTRUs, instead of normal handover. Other parameters may be used.

Source gNB 520 may select one or more candidate cells belonging to one more candidate gNBs 530, 530.1, and send HANDOVER REQWTRUST message 506, 508 requesting CHO. Source gNB 530 may consider candidate cells and gNBs which can satisfy the requirements of the group of WTRUs. Message 506, 508 may include multimodal/XRM session related information (e.g., session ID, required services), as well as information of flows and their requirements (e.g., the session includes a haptic flow requiring URLLC). One or more target gNB(s) 530, 530.1 may perform admission control 512, 514. Multimodal/XR session may be aware admission control 512, 514 may be performed if the multimodal/XR session aware information is sent to target gNB 530, 530.1.

Target gNB(s) 530, 530.1 may prepare for handover by sending 516, 518 the HANDOVER REQWTRUST ACKNOWLEDGE to source gNB 520. Message 516, 518 may indicate whether the requested WTRU group or only a subset of WTRUs, can be accepted for handover. This message may indicate whether gNB(s) support multimodal/XR sessions and services. The message may indicate one or more restrictions/rules for performing handover of multimodal/XR sessions and services. Such restrictions/rules may include a validity time window (e.g., start time, end time, duration) indicating when handover may be performed, for example.

The chosen WTRUs 510 may receive from the RAN (source gNB 520) an RRC message 522, 524 (e.g., RRCReconfiguration, handover command), containing the configurations of CHO candidate cell(s) and CHO execution condition(s). The CHO execution conditions may include the traffic characteristic/pattern information and traffic priority information, to be used for deciding when to perform the CHO. The CHO execution conditions may include the radio link measurements threshold values associated with the quality of the radio link between the WTRU and the candidate cell. This message may include the list of WTRUs that are chosen to be handed over together (e.g., for allowing them to communicate with each other for performing HO). This message may also indicate the possibility for performing the handover early. This may specify information on when the handover could be performed. This may be based on priority of the traffic. For example, handover may be advanced to occur before receiving traffic of a certain priority, or before transmitting traffic of a certain priority. This may be based on a marker in a PDU header. For example, handover may be advanced to occur before receiving traffic that has this marker or transmitting traffic that has this marker. In a second type of information this may refer to specific temporal information (e.g., specific time intervals). In a third type of information, this may refer to traffic quantity. For example, handover may be advanced to occur after the WTRU has received K DL PDUs, or after the WTRU has transmitted K UL PDUs. Moreover, the message may include more than one set of threshold values for triggering the handover. The threshold values are chosen based on the type of traffic.

WTRUs 510 may inform the Application about the eminent handover, so that decisions on relevant application layer adjustments can be made (e.g., decide whether to change video codec or not, due to disruption caused to the connectivity when performing handover). In some scenarios, a message indicating the possibility of a handover is sent to the relevant AF/AS(s), so that AF/AS(s) can decide whether to perform any relevant application layer operations. This message may include two sets of measurement thresholds. One soft HO conditions set indicating when the HO may/can be performed, allowing WTRU to make the final decision (e.g., based on XR traffic characteristics/patterns). A second hard HO conditions set indicates when the WTRU must perform HO.

WTRUs 510 may send an RRC response message 526, 528 (e.g. RRCReconfigurationComplete message) to source gNB 520. In some configurations, message 526,528 may include the chosen configurations, from the ones that are received at 522, 524 (e.g., the threshold values for performing handover). If early data forwarding is applied, source gNB 520 may send the EARLY STATUS TRANSFER message 532. Message 532 may include information of the WTRU group (e.g., multimodal session ID, WTRUs that are part of the group). Message 532 may include any information related to XRM session (e.g., ID) and/or information related to PDU set (e.g., PDU set ID), and/or multimodal synchronization/correlation information (e.g., multimodal session correlation ID) indicating any inter-dependency between PDUs/flows/sessions.

WTRUs 510 may start evaluating the CHO execution conditions at 534 for the candidate cell(s), including also the traffic characteristics/patterns, and may take information from any layer (e.g., application, PDU, PDU set, packet and data). WTRUs 510 may analyze traffic and decide, if the CHO must be performed before transferring high priority traffic. If there are any periods where traffic isn't transferred, so that those periods may be used for performing CHO (e.g., for the one or more WTRUs in the WTRU group configured with CDRX configurations, CHO may be configured to be performed during the OFF/sleep durations during which data transmissions/receptions are not expected by the WTRUs).

If there is traffic that can be sent before performing the CHO, in scenarios where the handover notifications are sent over the network (option 1) WTRU-1 510.1 sends a handover notification 536 to source gNB 520 for informing the decision made at 534. Notification 536 may include the time the handover is decided to be performed by WTRU-1 510.1 (this may take the form of absolute time, relative time, time window), and the information of the cell that it is handing over to (e.g., Cell ID).

All or a sub-set of WTRUs (WTRU-2 510.2 in FIG. 5A) in the group may receive a handover notification 538 from source gNB 520 informing that WTRU-1 510.1 is about to handover to target gNB 530. In scenarios where a sub-set of WTRUs are chosen (chosen by the RAN, e.g., based on target gNB capabilities, or may be decided based on requirements of the flows, e.g., synchronization threshold) to perform handover together, only the selected sub-set of WTRUs may receive notification 538. Notification 538 may indicate whether D2D/SL connectivity may be used to further synchronize handover time. It may also indicate whether to lower the CHO thresholds (and by how much), or to use another set of CHO thresholds. Notification 538 may include the information of the cell that it is handing over to (e.g., Cell ID).

In scenarios where the handover notifications are sent directly through D2D/SL communication (scenario 545), all or a sub-set of WTRUs (WTRU-2 510.2 in FIG. 5A) in the group receive a handover notification 542 from WTRU-1 510.1 directly using D2D communication, informing that WTRU-1 510.1 is about to handover to target gNB 530. In scenarios where a sub-set of WTRUs are chosen (may be decided based on requirements of the flows, e.g., synchronization threshold) to perform handover together, only the selected sub-set of WTRUs may receive this message. Notification 542 may include the time the handover is decided to be performed by WTRU-1 (this may take the form of absolute time, relative time, time window). Alternatively, notification 542 may indicate whether to lower the CHO thresholds (and by how much), or to use another set of CHO thresholds. notification 542 may include the information of the cell that it is handing over to (e.g., Cell ID). Alternatively, WTRU-1 510.1 may broadcast the message to all nearby WTRUs. The broadcast may include information of the WTRU group (e.g., multimodal session ID, WTRUs that are part of the group). Upon reception, the nearby WTRUs determine if they are part of the group that may be impacted by the handover of WTRU-1 510.1.

The WTRUs that received the handover notification 538, 542 may decide to perform the handover at the time WTRU-1 510.1 specified, or the handover thresholds may be lowered at 544 so that handover is easily performed. Alternatively, the WTRUs may select a different set of CHO threshold values at 544 (e.g., a second set of CHO conditions that was pre-configured). If a CHO candidate cell satisfies the corresponding CHO execution conditions (e.g., soft HO conditions), and traffic characteristics satisfy the traffic conditions, the WTRU may release the connectivity from the source cell before sending RACH/RRC to the target cell at 546. The WTRU may maintain connection with both source gNB 520 and target gNB 530, continuing traffic transmission from both cells, before detaching from source gNB 520. The WTRU may release the connection to the source cell once the WTRU receives a confirmation from the target cell (e.g., confirming that resources are allocated to satisfy requirements of the flows at 548). The WTRU may perform the handover during a time identified (e.g., specific time window, start and end of burst of data may be identified, and the handover is performed at the end of a burst). When hard CHO execution conditions are specified, and the corresponding conditions are met, then soft handover conditions may be ignored.

The WTRUs may synchronize with the selected cell at 546 and completes the handover procedure by sending RRCReconfigurationComplete message 548. Message 548 may include any information related to XRM session (e.g., ID) and/or information related to PDU set (e.g., PDU set ID), and/or multimodal synchronization/correlation information (e.g., multimodal session correlation ID) indicating any inter-dependency between PDUs/flows/sessions. Target gNB 530 may sends the HANDOVER SUCCESS message 552 to source gNB 520 informing that all or a subset of WTRUs in the group has successfully accessed the target cell.

Source gNB 520 may send SN STATUS TRANSFER message 554 to target gNB 530. Source gNB 520 may send HANDOVER CANCEL message 556 to all target gNBs 530.1, cancelling CHO for the WTRUs.

The present examples may allow a WTRU to notify some or all WTRUs in the group (e.g., ones with more stringent synchronization thresholds) of planned handover, such that the handover is performed in a coordinated manner. This may allow WTRUs to directly coordinate among themselves to ensure that they are handed over at a similar time, minimizing relative handover delays between the WTRUs. This enables the 5G system to ensure that delay requirements (e.g., synchronization threshold) of applications are met.

FIG. 5B includes a method 550 performed in a WTRU for coordinated handover for a group of WTRUs. Method 550 includes receiving at first coordinated handover configuration at 560. At 570, method 550 includes receiving a handover notification. The handover notification may provide an alert of a possible coordinated handover. The handover notification may include a handover condition to trigger the coordinated handover. At 580, method 550 includes setting a handover threshold based on the handover condition. At 590, method 550 includes monitoring the handover threshold. At 595, method 550 includes performing the coordinated handover when the handover threshold is met.

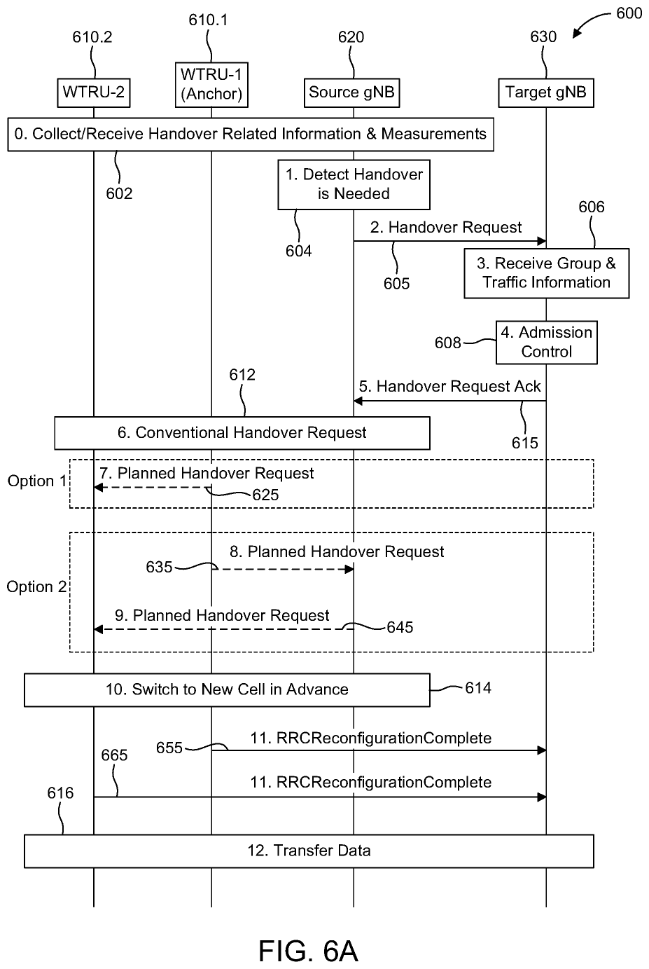

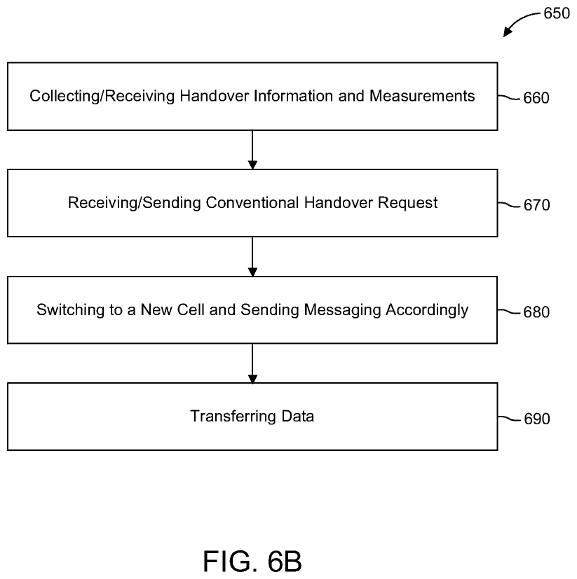

FIG. 6A illustrates a signal diagram 600 for an anchor-based handover. Anchoring based group handover may provide a WTRU within the WTRU group to act as an anchor device. As an anchor device, a WTRU may be allowed to coordinate the group handover, for performing handover. Such an approach may allow HO to be performed considering more accurate/up to date contextual information related to the WTRU group (e.g., connectivity conditions). The WTRUs within the group may continue to receive control messages from the RAN, however, the messages received from the anchor device may be able to override the same control message received from the RAN, providing the ability to coordinate handover for a group of WTRUs.

Two types of anchor-based handover may be performed. In a first example, the anchor WTRU 610.1 may send a planned handover request directly to other chosen WTRUs for handover using D2D/SL communication. In a second example, the anchor WTRU 610.1 may send the planned handover request to other chosen WTRUs via the network. In both scenarios, the anchor WTRU 610.1 may generate the planned handover request and overrides the handover requests sent by the network.

The anchor-based handover may include the elements described in FIG. 4A 402-414. Diagram 600 includes at 602 collecting/receiving handover related information and measurements, as well as application layer information and measurements. A configuration message may be sent to the chosen anchor WTRU 610.1 to provide information for configuring WTRU 610.1 to be the anchor WTRU and coordinate the HO procedures. This configuration message may specify when WTRU 610.1 starts and ends its role as the anchor WTRU. For example, by providing a specified time window, time duration or a geographical area. This configuration message may include information regarding the WTRUs (610.2) that anchor WTRU 610.1 is serving the anchor WTRU. In 602, WTRUs 610 that are part of a group receive a configuration message indicating that an anchor WTRU has been configured. This WTRU configuration message may also include a wait timer value, indicating how long a WTRU may wait for HO related messages from anchor WTRU 610.1, when HO related messages from the network arrives first, before acting on the HO related message received from the network. In 602, the collecting and receiving handover related information and measurements may include the anchor-based handover elements described in FIG. 4A 402-414. In 602, the measurements may include handover related information and measurements, as set forth, and may include application layer information and measurements.

Element 604 is similar to element 416 of FIG. 4A which includes detecting that at least one WTRU require handover. Element 605 is similar to element 418 of FIG. 4A includes source gNB 620 sending HANDOVER REQWTRUST to target gNB 630. Elements 606 and 608 are similar to elements 422 and 424 of FIG. 4A, respectively which includes target gNB 630 receiving information related to WTRU 610 group as well as the multimodal session at 606. Target gNB 630 performs admission control at 608 considering information received at 606. Element 615 is similar to element 426 of FIG. 4A which includes target gNB 630 acknowledging the handover request of 605 by responding 615 with RRC configuration to source gNB 620 with HANDOVER REQWTRUST ACKNOWLEDGE.

WTRUs 610 in the group may receive a handover request from the RAN (e.g., source gNB 620) as a RRCReconfiguration message. Element 612 is similar to element 438 of FIG. 4A. In some scenarios, the messages from the RAN may be sent to WTRUs 610 via anchor WTRU 610.1. WTRUs 610 may wait for the HO messages from anchor WTRUs 610.1, as configured at 602, before acting/executing based on this message.

In one example (illustrated as option 1 in FIG. 6A), anchor WTRU 610.1 directly sends the planned handover request 625 to WTRUs 610.2 that are chosen to be handed over together. This message 625 is similar to or takes the form of a RRCReconfiguration message. Message 625 may be similar to message 434 in FIG. 4A. Message 625 may be sent using unicast or multicast sidelink transmission to the WTRUs 610 that are chosen to be handed over together. Alternatively, this message 625 may be a broadcast sidelink transmission. In such a case, the receiving WTRUs may determine if they are in the group of WTRUs 610 that are chosen to be handed over together.

In another example (illustrated as option 2 in FIG. 6A), anchor WTRU 610.1 may send the planned handover request 635 to the RAN (source gNB 620), to be sent as a planned handover request 645 to the chosen subset of WTRUs 610. Message 645 is similar to or take the form of a RRCReconfiguration message. Message 645 may indicate (e.g., including the ID of) the issuer of the configuration (whether it is anchor WTRU or RAN node), to allow WTRUs 610 to determine whether message 645 is a config message form the RAN, or from anchor WTRU 610.1 and just forwarded by RAN. Message 645 may be similar to message 434 in FIG. 4A.

A chosen subset of WTRUs 610 receives the planned handover request 625, 645 from anchor WTRU 610.1 via RAN in case of message 645. Message 625, 645 may be similar to or take the form of a RRCReconfiguration message. Message625, 645 may be similar to message 434 in FIG. 4A. WTRUs 610 may inform the application about the handover and switch to the new cell at 614 at a similar time. Element 614 is similar to elements 442, 444 of FIG. 4A.

WTRUs 610 may send RRCReconfigurationComplete message 655, 665 to target gNB 630 once WTRUs 610 move the RRC connection to target gNB 630. In some configurations, WTRU 610 may include a reason/condition of handover in the message, e.g., handover performed because of choosing the threshold value set 1. In some configurations, the messages from the RAN may be sent to WTRUs 610 via anchor WTRU 610.1.

WTRU 610 may transfer and receive data at 616. Element 616 is similar to element 452 of FIG. 4A. In some configurations, the messages from the RAN may be sent to WTRUs 610 via anchor WTRU 610.1.

The order of the steps may change, depending on when anchor WTRU 610.1 decides to perform the handover. In some configurations, control traffic or user plane traffic or both may be routed via the Anchor device(s).

FIG. 6B illustrates a method 650 performed by an anchor WTRU. Method 650 includes collecting/receiving handover related information and measurements at 660, such as from the source gNB. At 670, method 650 may include the anchor WTRU receiving conventional handover request from the source gNB, and may include the anchor WTRU sending conventional handover requests to the other WTRUs as described with respect to option 1 and option 2 above. At 680, method 650 includes switching to a new cell and sending messaging accordingly. At 690, method 650 includes transferring data via the target gNB.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed in a wireless transmit receive unit (WTRU) for coordinated handover for a group of WTRUs, the method comprising:
receiving information indicating a first coordinated handover configuration;
receiving a handover notification, the handover notification alerting to a coordinated handover for the group of WTRUs and including at least one handover condition to trigger the coordinated handover;
determining a handover threshold based on the at least one handover condition; and
performing the coordinated handover based on determining a measurement value meets the handover threshold.

2. The method of claim 1, wherein the at least one handover condition comprises an overall QoE falling below a threshold.

3. The method of claim 1, wherein the measurement value comprises traffic burst indicators.

4. The method of claim 1, wherein the handover notification is communicated using device-to-device connectivity.

5. The method of claim 1, further comprising monitoring the measurement value.

6. The method of claim 1, wherein the set handover threshold is communicated to the group of WTRUs.

7. The method of claim 1, wherein the first coordinated handover configuration is communicated via sidelink communication.

8. The method of claim 1, wherein the first coordinated handover configuration is communicated via PC5 communication.

9. The method of claim 1, wherein the group of WTRUs include a common group identification (ID.

10. The method of claim 1, wherein the group of WTRUs are grouped based on a common application.

11. The method of claim 1, wherein the group of WTRUs are grouped based on a common application experience.

12. A wireless transmit receive unit (WTRU) for performing coordinated handover for a group of WTRUs, the WTRU comprising:
a processor; and
a transceiver communicatively coupled to the processor,
the processor and transceiver operating to:
receive information indicating a first coordinated handover configuration;
receive a handover notification, the handover notification alerting to a coordinated handover for the group of WTRUs and including at least one handover condition to trigger the coordinated handover;
determine a handover threshold based on the at least one handover condition; and
perform the coordinated handover based on determining a measurement value meets the handover threshold.

13. The WTRU of claim 12, wherein the at least one handover condition comprises an overall QoE falling below a threshold.

14. (canceled)

15. The WTRU of claim 12, wherein the handover notification is communicated using device-to-device connectivity.

16. (canceled)

17. The WTRU of claim 12, wherein the first coordinated handover configuration is communicated via sidelink communication.

18. The WTRU of claim 12, wherein the group of WTRUs include a common group identification (ID.

19. The WTRU of claim 12, wherein the group of WTRUs are grouped based on a common application.

20. The WTRU of claim 12, wherein the group of WTRUs are grouped based on a common application experience.

21. The method of claim 1, wherein the handover notification is communicated is received from a base station.

22. The method of claim 1, wherein the first coordinated handover configuration is communicated from a base station.
